(19) United States
(12) Patent Application Publication
(10) Pub. No.: US 2007/0274392 A1
(43) Pub. Date: Nov. 29, 2007

(54) Pattern-Search Based Method And Apparatus For Context-Adaptive Variable Length Coding/Decoding

(76) Inventors: Shau-Yin Tseng, Hsinchu Hsien (TW); Tienwei Hsieh, Taipei (TW)

Correspondence Address: Lin & Associates Intellectual Property, Inc., Post Office Box 2339, Saratoga, CA, 95070-0339, US

(21) Appl. No.: 11/459,019

(22) Filed: Jul. 21, 2006

(30) Foreign Application Priority Data
May 26, 2006 (TW) 095118776

(51) Int. Cl. H04N 11/04; H04N 7/12

(52) U.S. Cl. 375/240.23; 375/240.26

(57) ABSTRACT

A pattern-search based method and apparatus for context-adaptive variable length coding/decoding (CAVLC/CAVLD) is provided. The method analyzes the correlation between bit patterns and blocks. Before CAVLD, a step of bit-stream pattern search is conducted. If a pattern is matched in a look-up table, this invention skips the CAVLD procedure and reconstructs a block directly. Before CAVLC, a step of zig-zag ordered coefficients search is conducted. If a sequence of zig-zag ordered coefficients is matched in a look-up table, a corresponding coded bit-stream can be obtained directly. Compared with the standard CAVLD procedures, this invention improves about 10% performance in memory access speed.

### FIELD OF THE INVENTION

The present invention generally relates to video coding/decoding, and more specifically to a pattern-search based method and apparatus for context-adaptive variable length coding/decoding.

### BACKGROUND OF THE INVENTION

H.264/advance video coding (AVC) is a new generation video coding standard, and is a block-based compression method. This video coding standard provides multiple compression tools and features. Compared with the earlier technologies, the AVC standard greatly improves the video quality. To facilitate the flexibility and economic effect of a plurality of products, a variety of multimedia application software are developed for the programmable CPU or DSP, which also increases the complexity of H.264/AVC. For example, the software-based real time decoder requires more efficient CPU and faster algorithm.

For computing complexity, the compression tools, such as the motion compensation of pixel interpolation, the entropy decoding of context-adaptive variable length codes (CAVLC), and the de-block filter, will require more time for computing. The basic behavior of CAVLC is similar to the behavior of variable length codes. The software implementation of the variable length codes can be categorized as bit-serial methods and bit-parallel methods. The bit-serial methods are not suitable for high efficiency real-time application because the methods require a longer period to decode a codeword. On the other hand, the bit-parallel methods can reduce the memory access and improves performance.

The simplest way of bit-parallel methods is to use a look-up table for search. The look-up table is addressed by the input bits, and includes the decoded symbols and the code length. The code length determines the location that the index of bit-stream should be moved to. The look-up table must be able to be addressed by the longest bit length; however, this may waste much memory space because the shorter codes may have multiple repetitive entries in the look-up table.

A possible solution is to use multi-pass look-ups. First, a few bits are used for addressing the table to look up a decoded symbol. If the symbol is not found in the table, a few more bits will be read for addressing a second table for a second look-up, and so on. Although, this solution reduces the memory usage, it requires more time to process.

CAVLC is a variable length code used by H.264. CAVLC uses a plurality of extended dedicated tables, and depends on the context block or symbol to determine which table to look up from. The design concept is to use different methods to divide the table of variable length codes to save memory space, then use arithmetic calculation to substitute the less efficient look-up table, and construct multi-symbol VLC for decoding a plurality of consecutive symbols at once. FIG. 1 shows a flowchart of CAVLD decoding, including six steps, and each step using a different table. The CAVLD flowchart is described as follows.

Step 101 is to decode the total number TC of non-zero coefficients and the number T1s of ±1, where TC ranging from 0-16, and T1s ranging from 0-3. This step is to determine the table to look up from according to the nC value. The nC value is the average value of the total non-zero coefficient number of the upper decoded block and left-hand decoded block of the current block.

Step 102 is to decode the sign of T1 based on the T1s. A “0” indicates positive sign and “1” indicates a negative sign.

Step 103 is to decode the non-zero coefficient levels sequentially based on TC. The table to look up from in this step depends on the previous decoded non-zero coefficient.

Step 104 is to decode the total number of leading zeros of the non-zero coefficients. The table to look up from in this step depends on the TC.

Step 105 is to decode the number of leading zeros of each non-zero coefficient. The table to look up from in this step depends on the number of the leading zeros of the non-zero coefficient.

Step 106 is to reconstruct the 16 zig-zag ordered coefficients based on the values from each previous step.

For example, the CAVLD bit-stream (0001 0011 1100) can be used to decode the 16 zig-zag ordered coefficients (2, 0, −1, 0, 0, 0, 0, 0, 0, 0, 0, 0, 0, 0, 0, 0). Three different tables are required for the decoding process, including table 9-5, table 9-7, and table 9-10. FIG. 2 describes the process of CAVLD decoding bit-stream (0001 0011 1100).

In the block-based video compression standard, the variable length code (VLC) can be used for coding 4×4 or 8×8 block. For example, the baseline profile of H.264 uses CAVLC to code the residual data of 4×4 blocks. A 4×4 block includes 16×16=256 bits. FIGS. 3A & 3B show the statistic table of using CAVLC to compress a 4×4 block when compressing four CIF and five QCIF images, respectively. The first column of the statistics indicates the number of bits used by a 4×4 block. For example, after the first CIF image is compressed, the number of 4×4 blocks using 1-5 bits is 80,363, the number of 4×4 blocks using 6-10 bits is 31,380, the number of 4×4 blocks using 11-150 bits is 28,477, and so on. The number of 4×4 blocks using 41-45 bits is 4,565. The statistic tables show that about 60% of the blocks uses less than 15 bits.

Based on this technology, Tseng et al presented the statistics on the frequency of 4×4 block in the article “The Profile of H.264” of “SoC technical Journal STC/ITRI, Taiwan, Vol. 3, pp. 111-119, November 2005. The statistics include the displacement vector of sub-pel, the displacement vector of CIF and QCIF images, skip mode, the number of used bits of compressed 4×4 blocks of CIF and QCIF images, and the number of the all-zero 4×4 blocks before and after inverse quantization (IQ) and inverse transformation (IT).

Taking the most frequent blocks as a pattern in the analysis of the statistics shows that the decoding computation complexity can be reduced even the blocks of the image are not regularly arranged.

The above article, while collects the statistics, does not differentiate the blocks having the nC value. However, the same 4×4 blocks may have different nC values, and can be coded as different bit-stream. In other words, the above article does not analyze the correlation between the bit pattern and the block.

### SUMMARY OF THE INVENTION

The present invention has been made to overcome the above-mentioned drawback of conventional methods. The present invention further analyzes the correlation between the bit pattern and the block, and uses the pattern-search to implement a variable length coding/decoding method. During the compression, a hash table is used before the entropy coding to match the zig-zag ordered coefficients. If matched, the coded bit-strea can be obtained directly. During the decompression, a step of pattern-search is added before the entropy decoding. If the matched bit-pattern is found, the 16 zig-zag ordered coefficients can be obtained directly.

Before the entropy decoding, the pattern-search step further includes the following steps. First, a block is extracted and a byte is read from the bit-stream. The byte is used as the index to address an entry in a look-up table. The corresponding field of the entry is used to determine if a match is found. If matched, the bit-stream pattern can be read from the matched entry. Based on the bit-stream pattern to obtain the corresponding zig-zag ordered coefficients from a bit-stream pattern zig-zag ordered coefficient table. If not matched, an entropy decoding process is conducted.

Similarly, before the entropy coding, the matching zig-zag ordered coefficient step further includes the following steps. First, the hash value of zig-zag ordered coefficients to be matched is computed. The hash value is then used to index the hash table to find the entry. The corresponding field of the entry is used to determine if a match for zig-zag ordered coefficients is found. If matched, the zig-zag ordered coefficients can be obtained based on the matched zig-zag ordered coefficients. If not matched, an entropy coding process is conducted.

Therefore, if a bit-stream pattern can be quickly found during the decompression, the entropy decoding process of the video decompression standard can be skipped, and the 4×4 or 8×8 blocks can be obtained directly. Similarly, if the zig-zag ordered coefficients can be found quickly during the compression, the entropy coding process of the video compression standard can be skipped, and the code can be obtained directly. The result of the experiments shows that the performance entropy coding/decoding is improved by 10%.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 shows a flowchart of a CAVLD decoding process.

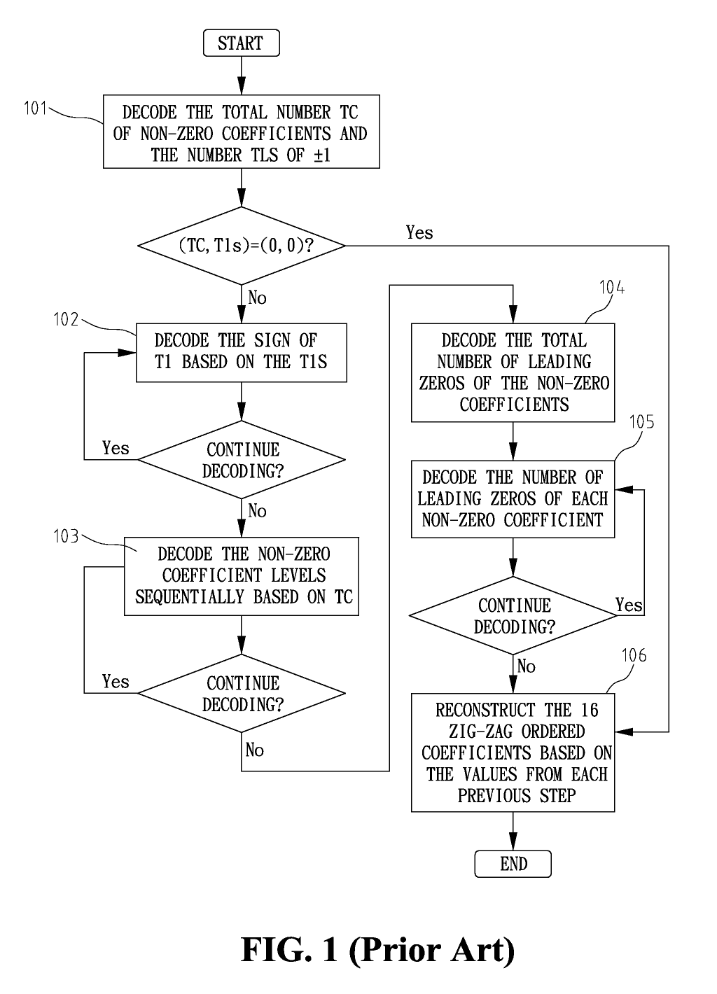

FIG. 2 shows the CAVLD decoding bit-stream (0001 0011 100).

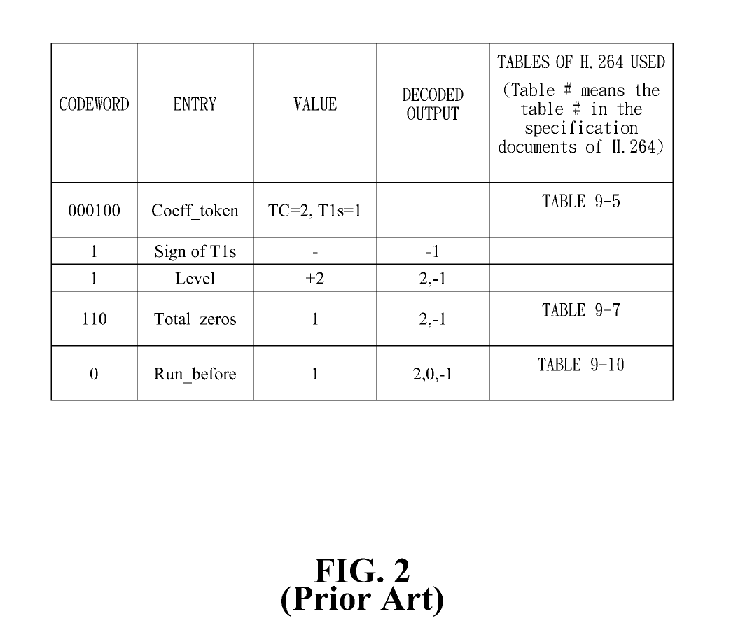

FIG. 3A shows the statistics of using CAVLC to compress a 4×4 block when compressing 4 CIF images.

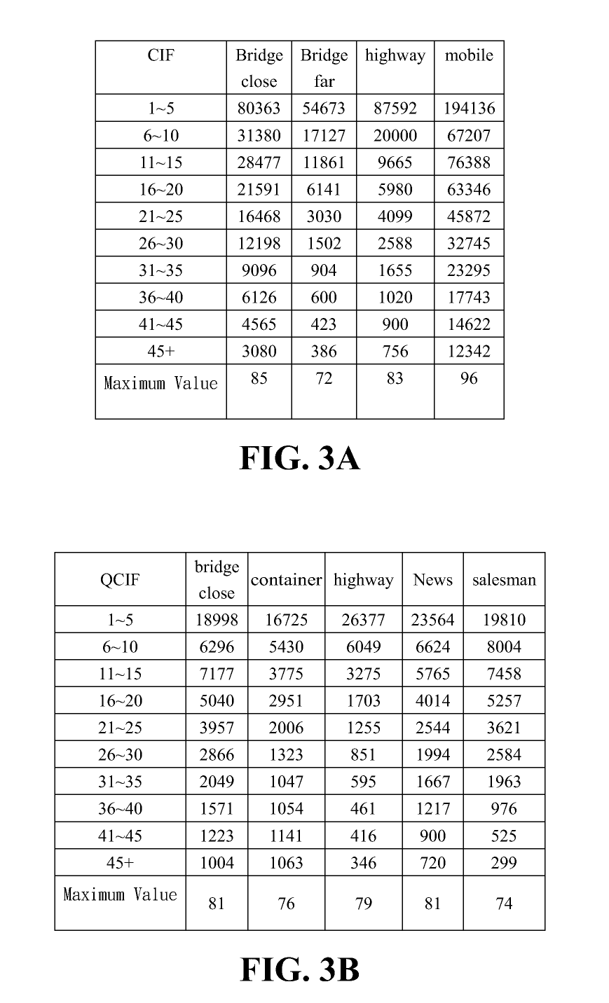

FIG. 3B shows the statistics of using CAVLC to compress a 4×4 block when compressing 5 QCIF images.

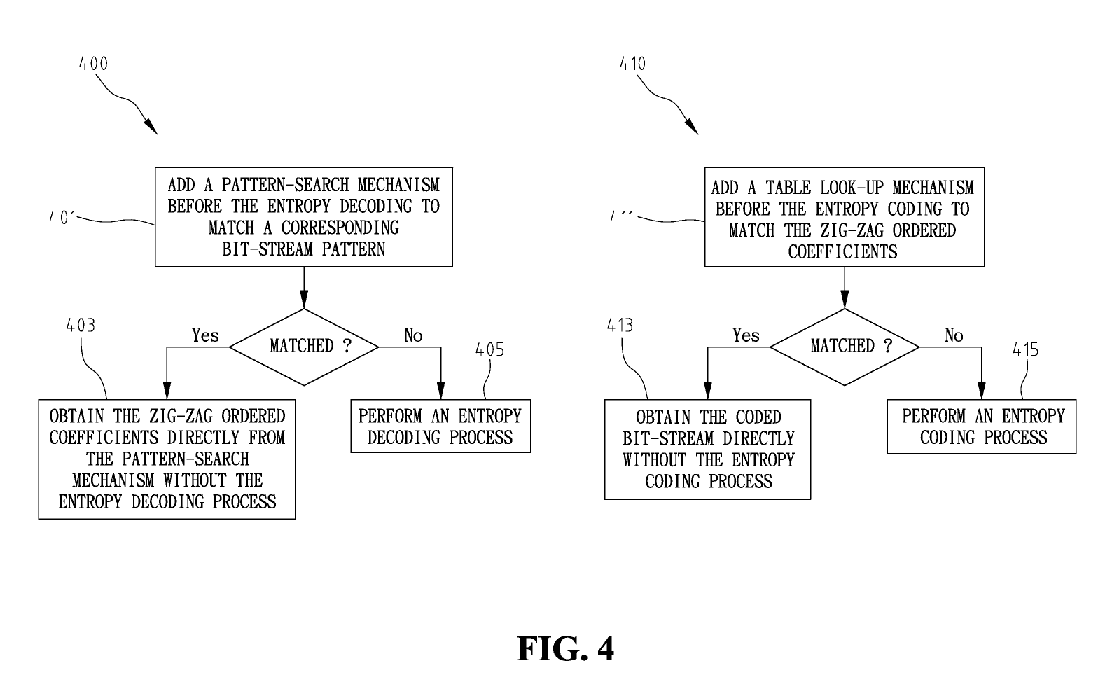

FIG. 4 shows the decompression and compression processes according to the present invention.

FIG. 5 shows the tally percentage of bit length of 4000 bit-stream patterns.

FIG. 6A shows an example of the frequent bit-stream patterns.

FIG. 6B shows the zig-zag ordered coefficients obtained by CAVLD decoding the bit-stream patterns of FIG. 6A.

FIG. 7 shows a look-up table according to the present invention.

FIG. 8 shows a flowchart of the pattern-search process according to the present invention.

FIG. 9 shows a hash table constructed from FIG. 6B.

FIG. 10 shows the zig-zag ordered coefficients matching process according to the present invention.

FIG. 11 shows the performance comparison between the present invention and CAVLD on 7 test sequences.

FIG. 12 shows a pattern-search table of the extension of FIG. 6B to encompass the coefficients of the blocks after IT and IQ.

FIG. 13A shows a block diagram of a decompression module for the decompression process of FIG. 4.

FIG. 13B shows a block diagram of a compression module for the compression process of FIG. 4.

### DETAILED DESCRIPTION OF THE PREFERRED EMBODIMENTS

As described earlier, the conventional technology collects the statistic data of the frequency of 4×4 blocks without differentiating the blocks having the nC value. However, the same 4×4 blocks may have different nC values, and will be coded into different bit-stream. For example, when nC is 0, the 4×4 block (2, 0, −1, 0, 0, 0, 0, 0, 0, 0, 0, 0, 0, 0, 0, 0) is coded as bit-stream (0001 0011 100). However, when nC is 2, the 4×4 block (2, 0, −1, 0, 0, 0, 0, 0, 0, 0, 0, 0, 0, 0, 0, 0) is coded as bit-stream (0011 1111 1000).

In other words, there exists a correlation between the bit pattern and the block. Therefore, if the specific bit-stream (0001 0011 1100) can be quickly matched in the bit-stream during the decoding, the 16 zig-zag ordered coefficients (2, 0, −1, 0, 0, 0, 0, 0, 0, 0, 0, 0, 0, 0, 0, 0) can be obtained directly without the CAVLD process. Similarly, if the 16 zig-zag ordered coefficients (2, 0, −1, 0, 0, 0, 0, 0, 0, 0, 0, 0, 0, 0, 0, 0) can be matched quickly during the coding, the coded bit-stream (0001 0011 1100) can be obtained directly without the CAVLC process.

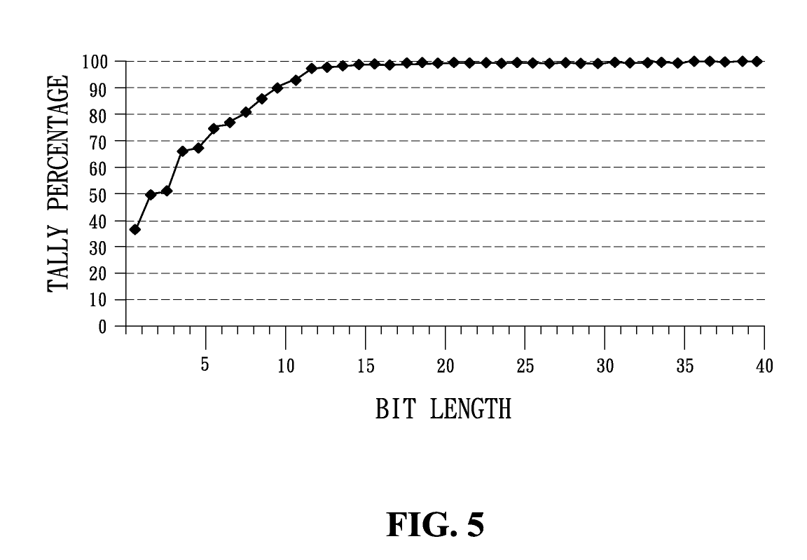

Based on this characteristic, the pattern-search based method for variable length coding/decoding of the present invention includes a decompression process and a compress process, as described in FIG. 4 respectively.

In the decompression process 400 of FIG. 4, a pattern-search mechanism is added before the entropy decoding to match a corresponding bit-stream pattern, as shown in step 401. If matched, the zig-zag ordered coefficients can be obtained directly from the pattern-search mechanism without the entropy decoding process, as shown in step 403. Otherwise, an entropy decoding process is conducted, as shown in step 405.

A compression process 410 of FIG. 4 includes a table look-up mechanism before the entropy coding to match the zig-zag ordered coefficients, as shown in step 411. If matched, the coded bit-stream is obtained directly without the entropy coding process, as shown in step 413. Otherwise, an entropy coding process is conducted, as shown in step 415.

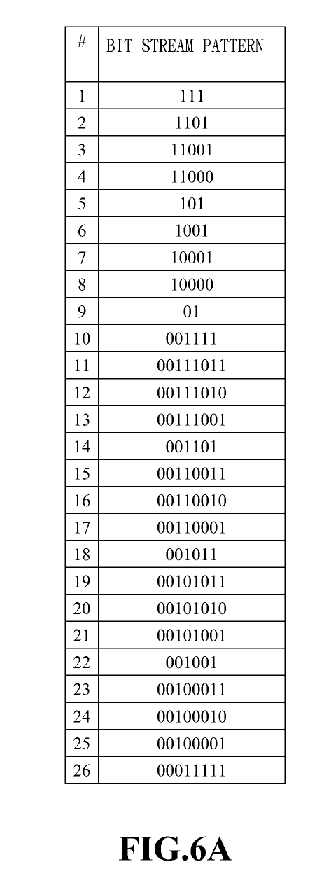

The present invention further analyzes the correlation between the bit pattern and the block. First, the number of each type of 4×4 block is calculated and a frequency bit-stream pattern is produced. The bit lengths of the bit-stream pattern are different. Some are 2-bit long, and some are 3-bit long. FIG. 5 shows the percentage of the bit length of 4000 bit-stream pattern samples. The x-axis indicates the bit length, and the y-axis indicates the tally percentage. As shown in FIG. 5, 81.07% of the bit-stream patterns has the bit length less than 8, and 96.93% of the bit-stream patterns has the bit length less than 12.

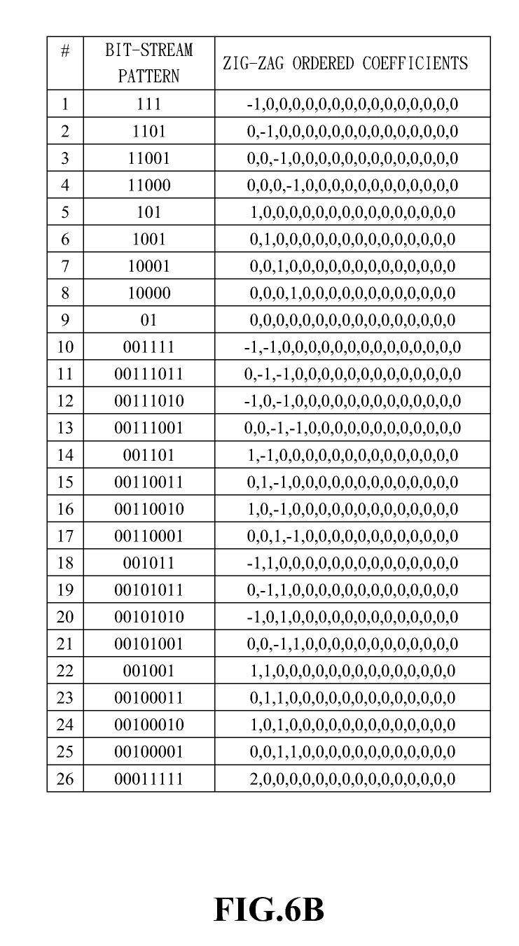

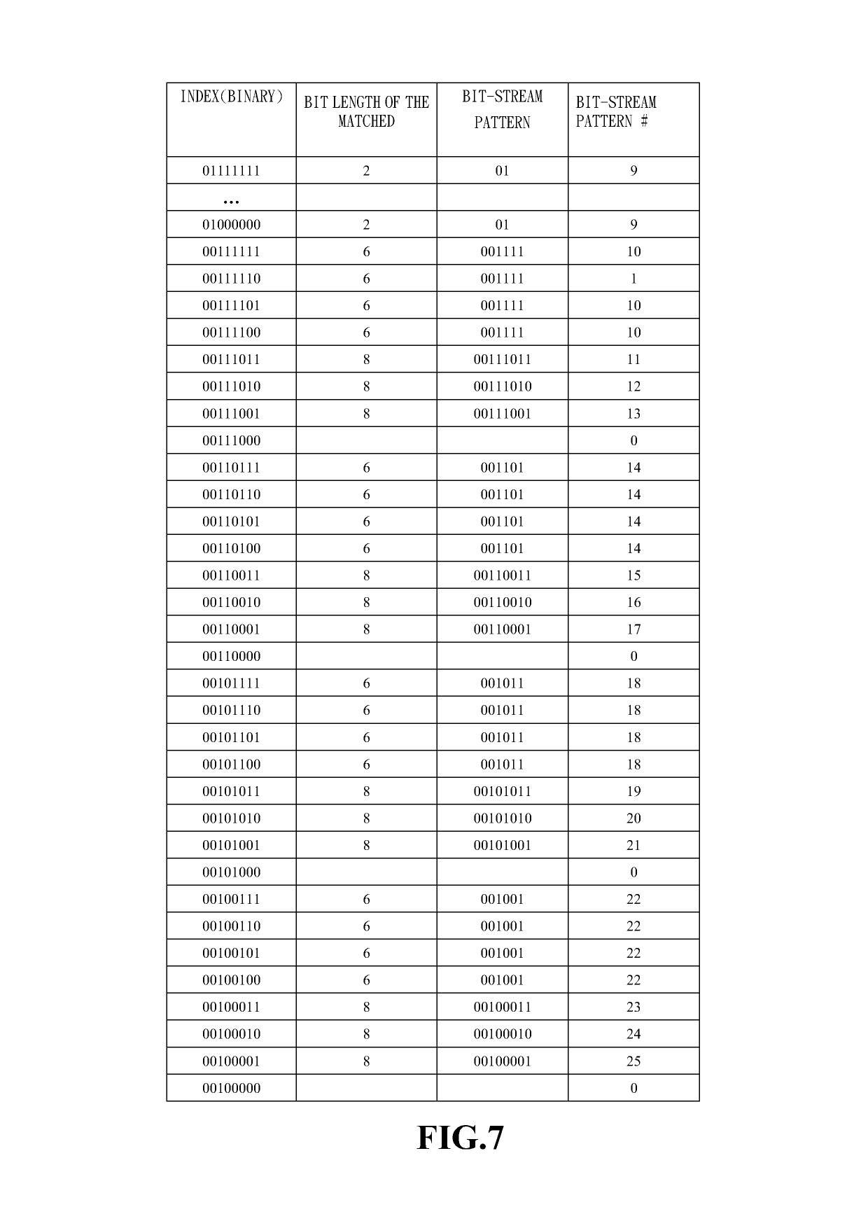

FIG. 6A shows an example of bit-stream pattern. The first field is the ID number of the bit-stream pattern, and the second field is the corresponding bit-stream pattern. For example, #9 is a 2-bit bit-stream pattern 01, 31 is a 3-bit bit-stream pattern 111, and #5 is a 3-bit bit-stream pattern 101. The statistics show that there are many types of bit-stream patterns. FIG. 6A shows 26 bit-stream patterns.

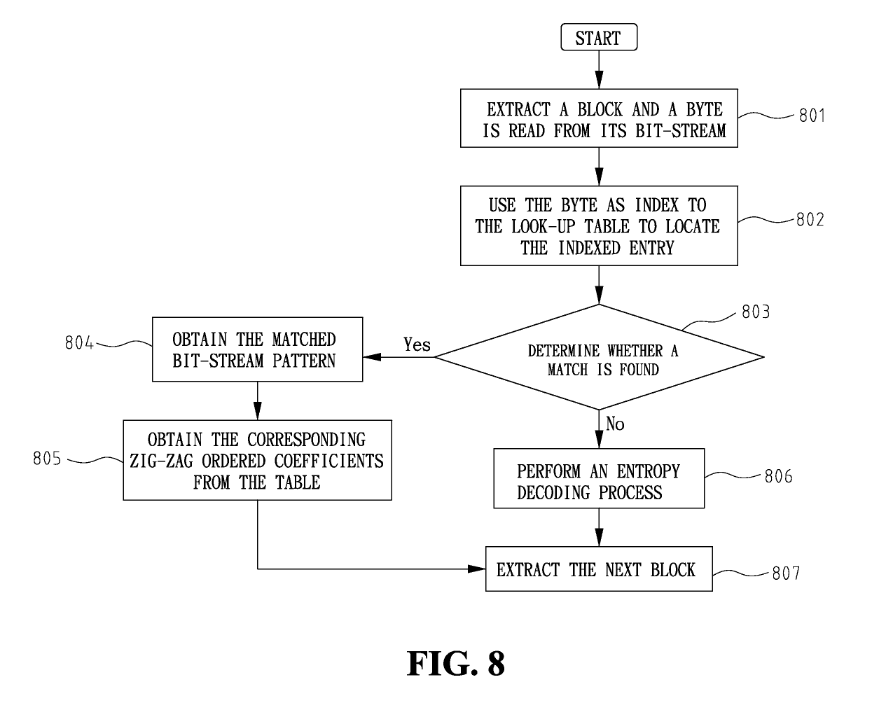

Without the loss of generality, the present invention uses an 8-bit pattern as an embodiment for constructing a look-up table of FIG. 6A, which will be described in FIG. 7. Also, a byte (8 bits) is read from the bit-stream to use as an index.

Then, the present invention uses CAVLD to decode the bit-stream patterns to obatain the zig-zag ordered coefficients, as shown in the table FIG. 6B. The entry of the zig-zag ordered coefficient table includes three fields. The first field is the ID number of the bit-stream pattern, the second field is the bit-stream pattern, and the third field is the corresponding 16 zig-zag ordered coefficients.

With the zig-zag ordered coefficient table, if the bit-stream pattern can be matched quickly before decoding, the entropy decoding process is skipped, and the corresponding 16 zig-zag ordered coefficients are obtained directly. Similarly, if the corresponding 16 zig-zag ordered coefficients are matched quickly before coding, the coded bit-stream can be obtained directly.

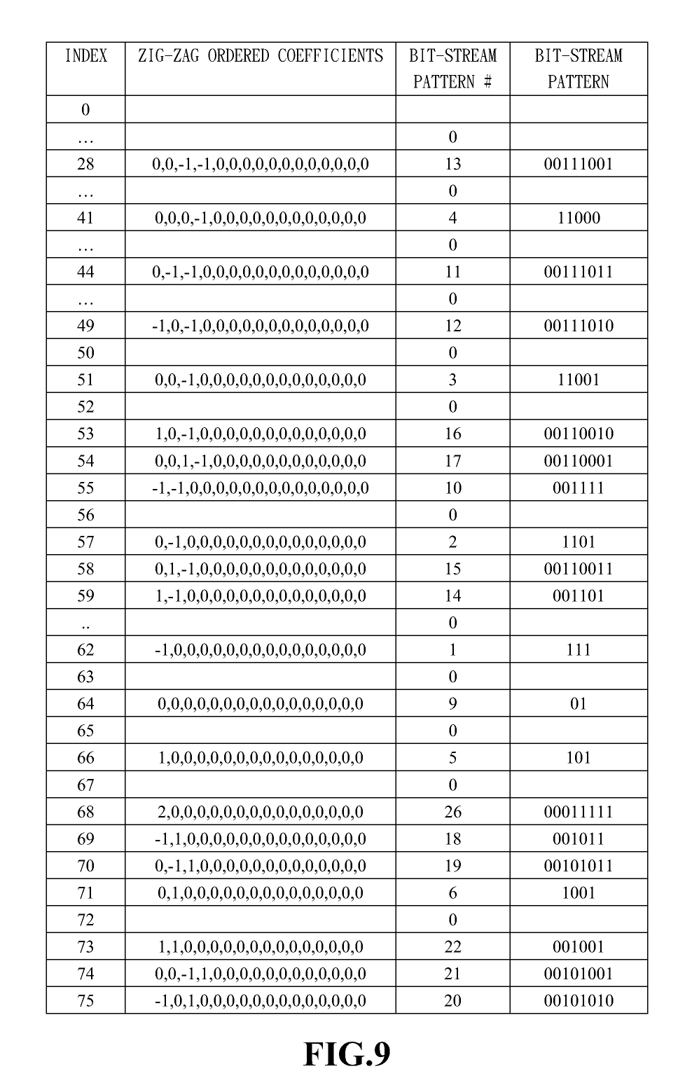

To speed up the matching process of the bit-stream pattern, the present invention uses bit-stream as the index. Without the loss of generality, the present invention uses 8-bit stream as an embodiment to construct the look-up table of FIG. 7. The look-up table includes 256 entries, called, entry 0, 1, . . . , 255. Each entry includes four fields, and they are index, bit length of the matched, bit-stream pattern of the matched and the ID number of the bit-stream pattern in FIG. 6A. With the look-up table of FIG. 7, FIG. 8 further describes the flow of the bit-stream pattern search process.

Referring to FIG. 8, a block, such as a 4×4 block, is extracted and a byte is read from its bit-stream, as shown in step 801. Step 802 is to use the byte as index to the look-up table to locate the indexed entry. Step 803 is to determine whether a match is found based on the fourth field X₄, the ID number of the bit-stream pattern in FIG. 6A. If X₄ is greater than 0, a match is found, and proceed to step 804 to obtain the third field X₃, the matched bit-stream pattern. Step 805 is to obtain the corresponding zig-zag ordered coefficients from the table in FIG. 6B based on X₃.

When X₄=0 in step 803, it means no match is found. Therefore, an entropy decoding process must be conducted, such as CAVLD, as shown in step 806. Then, step 807 is to extract the next block and repeat the above steps.

In summary, according to the present invention, a bit-stream pattern search step is added before the entropy decoding. If a match is found, the entropy decoding is skipped and the corresponding 16 zig-zag ordered coefficients can be obtained directly.

It is worth mentioning that when nC≧8, the present invention does not construct a look-up table as in FIG. 7. This is because the look-up table is sufficient to cover most of the 4×4 or 2×2 blocks. The few blocks without the matching bit-stream patterns can be decoded using entropy decoding more efficiently.

Similarly, if the specific zig-zag ordered coefficients, such as (2, 0, −1, 0, 0, 0, 0, 0, 0, 0, 0, 0, 0, 0, 0, 0), can be matched quickly before coding, the coded bit-stream, such as (0001 0011 1100) can be obtained directly without CAVLC.

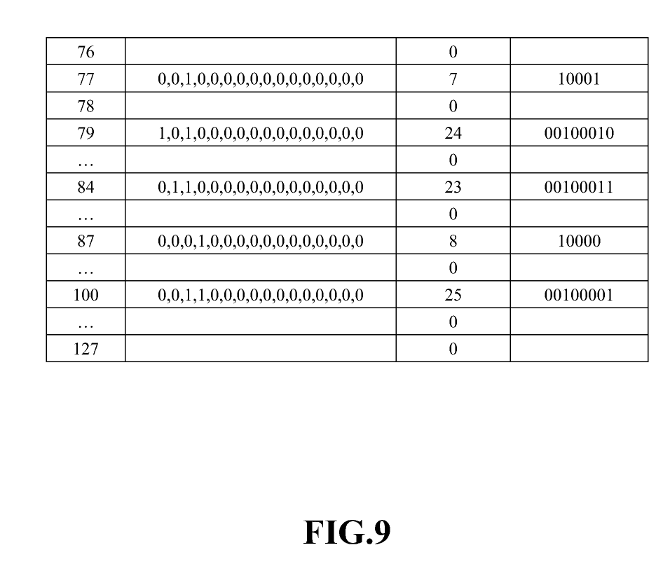

As the modulus coefficients are 16-bit signed numbers, a hash table is constructed using the FIG. 6B to speed up the matching of zig-zag ordered coefficients (x1, x2, x3, x4, x5, x6, x7, x8, x9, x10, x11, x12, x13, x14, x15, x16), as shown in FIG. 9. The hash table incldues 256 entries. Each entry includes four fields. They are index, zig-zag ordered coefficients, ID number of matched bit-stream pattern in FIG. 6A and bit-stream pattern. The following is an embodiment of the hash function h:

h (x1, x2, x3, x4, x5, x6, x7, x8, x9, x10, x11, x12, x13, x14, x15, x16)=(x1, x2, x3, x4, x5, x6, x7, x8, x9, x10, x11, x12, x13, x14, x15, x16)·(2,7,13,23,0,0,0,0,0,0,0,0,0,0,0,0)+64.

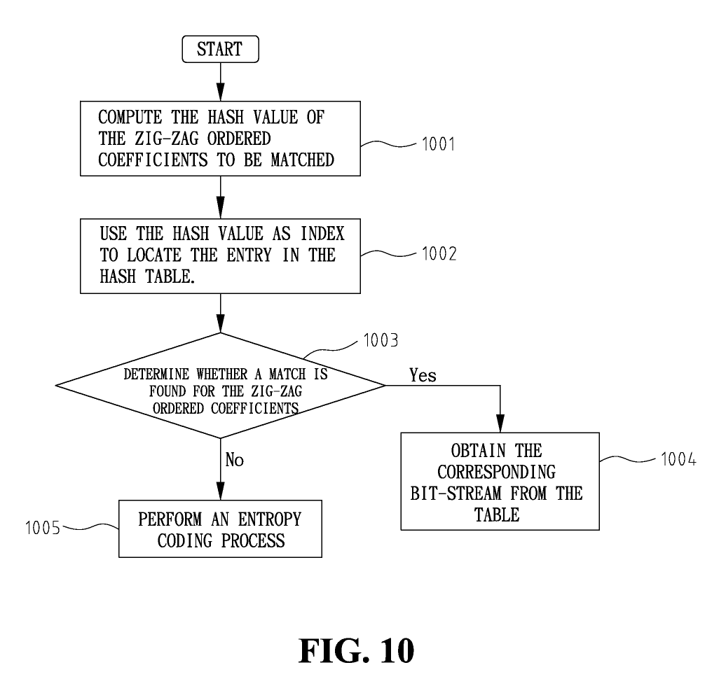

Using this hash table, FIG. 10 further describes the flowchart of the matching zig-zag ordered coefficients process. Referring to FIG. 10, step 1001 is to compute the hash value of the zig-zag ordered coefficients (x1, x2, x3, x4, x5, x6, x7, x8, x9, x10, x11, x12, x13, x14, x15, x16) to be matched. Step 1002 is to use the hash value as index to locate the entry in the hash table. Step 1003 is to determine whether a match is found for the zig-zag ordered coefficients according to the third field y₃, the ID number of the bit-stream pattern in FIG. 6A. When y₃ is greater than 0, a match is found, and proceed to step 1004 to obtain the corresponding bit-stream from the table FIG. 6B according to y₃.

When y₃=0, no match is found. Therefore, an entropy coding process, such as CAVLC, as shown in step 1005. The next zig-zag ordered coefficients are then selected to repeat the above steps.

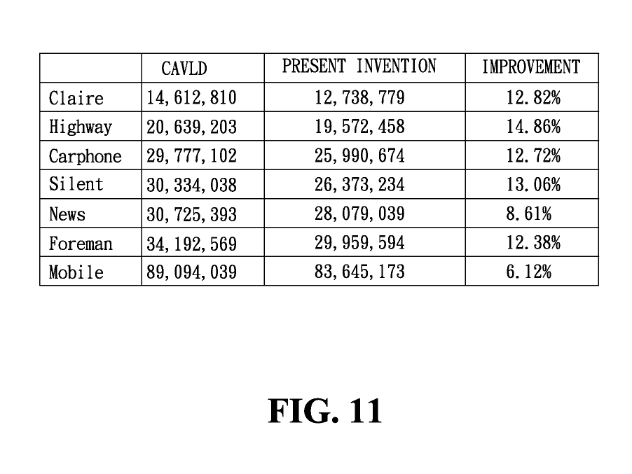

To verify the effectiveness of the present invention, an ARM based embedded system is used to implement the pattern-search based method for variable length coding/decoding of the present invention, including seven test sequences, called mobile, foreman, carphone, silent, news, highway, and Claire. FIG. 11 shows the comparison of the performance of the standard CAVLD and the present invention on the seven test sequences. The comparison is on the memory count cycles. As shown in IFG. 11, the present invention improves 14.86% on highway sequence, 12.38% on foreman sequence, and 6.12% on mobile sequence in comparison with CAVLD.

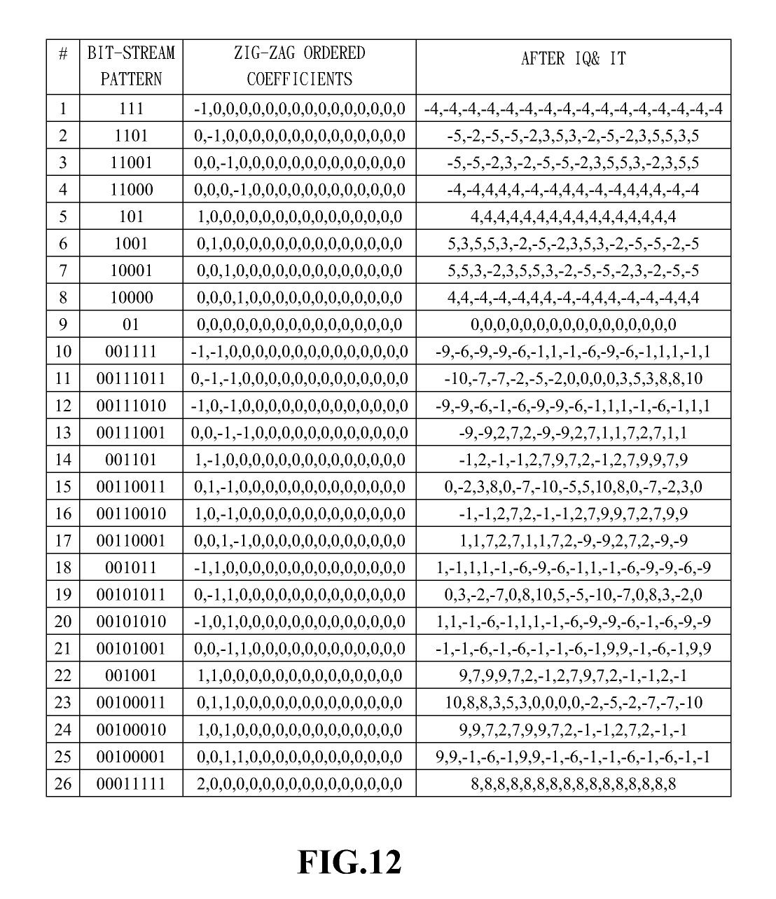

In addition, because the behavior of the inverse transformation (IT) and inverse quantization (IQ) are regular, and is limited to the coefficients of the 4×4 blocks. The present invention extends FIG. 6B to encompass the coefficients of the blocks after IQ&IT to construct a new pattern-search table, as shown in FIG. 12. Without the entropy decoding and IQ & IT processes, a 4×4 block after IT can be reconstructed directly.

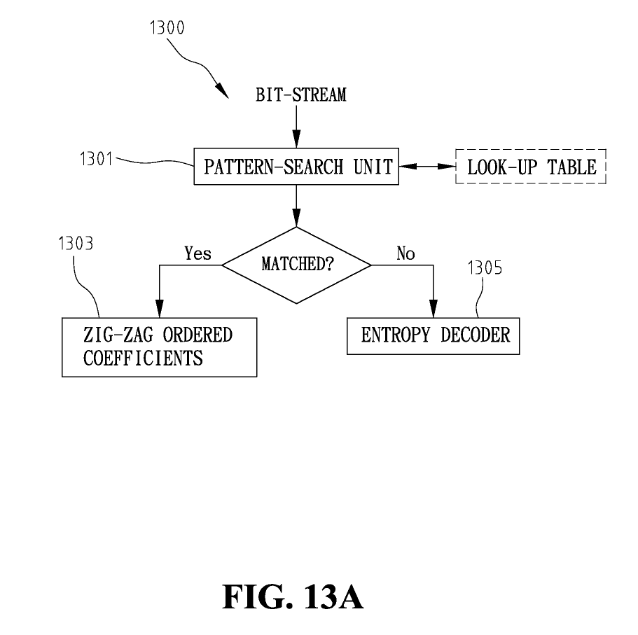

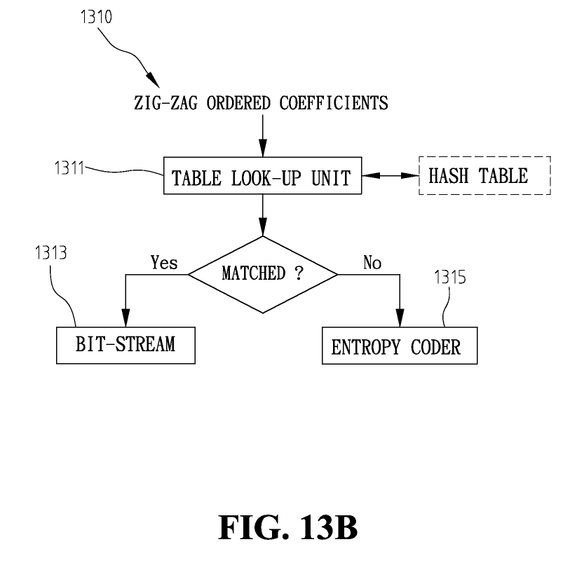

According to the method of the present invention, FIGS. 13A and 13B show the block diagram of an apparatus for the decompression and compression process of FIG. 4, respectively.

FIG. 13A shows a decompression module 1300, including a pattern-search unit 1301 and an entropy decoder 1305 Using the look-up table in FIG. 7, pattern-search unit 1301 uses an input bit-stream to match a corresponding bit-stream pattern. If matched, pattern-search unit 1301 obtains zig-zag ordered coefficients 1303 from the look-up table. If no match is found, pattern-search unit 1301 informs entropy decoder 1305 to perform entropy decoding process.

According to the present invention, pattern-search unit 1301 reads a byte from the bit-stream, which is used as index to the look-up table for matching the bit-stream pattern to obtain the zig-zag ordered coefficients.

FIG. 13B shows a compression module 1310, including a table look-up unit 1311 and an entropy coder 1315 Using the hash table in FIG. 9, table look-up unit 1311 tries to match the input zig-zag ordered coefficients. If matched, table look-up unit 1311 obtains bit-stream 1313 from the hash table. If no match is found, table look-up unit 1311 informs entropy coder 1315 to perform entropy coding process.

According to the present invention, table look-up unit 1311 computes a hash value 1313 from the input zig-zag ordered coefficients, which is used as index to the hash table for matching the zig-zag ordered coefficients.

In summary, the present invention analyzes the correlation between the bit pattern and the block, and provides a pattern-search based method an apparatus for variable length coding/decoding. The present invention is applicable to the reconstruction of 4×4 or 8×8 blocks and 4×4 blocks after IT, without the standard CAVLD, IT and IQ processes. In comparison with the standard CAVLD, the present invention improves the entropy coding/decoding performance by 10%.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A pattern-search based method for variable length coding and decoding, comprising the steps of:
a decompression process, wherein a pattern-search mechanism is added before an entropy decoding during said decompression process to match a bit-stream pattern, if matched, a sequence of corresponding zig-zag ordered coefficients is obtainable directly from said pattern-search mechanism, if not matched, said entropy decoding is performed; and
a compression process, wherein a table look-up mechanism is entered into before an entropy coding during said compression process, said table look-up mechanism is for matching said sequence of corresponding zig-zag ordered coefficients, if matched, a corresponding bit-stream being obtainable directly from said table look-up mechanism, if not matched, said entropy coding being performed.

2. The method as claimed in claim 1, wherein said entropy decoding is for decoding context-adaptive variable length codes.

3. The method as claimed in claim 1, wherein said entropy coding is for coding with context-adaptive variable length codes.

4. The method as claimed in claim 1, wherein said pattern-search mechanism of said decompression process further includes a look-up table and a bit-stream pattern zig-zag ordered coefficient table.

5. The method as claimed in claim 4, wherein said pattern-search mechanism further includes the following steps to match a corresponding bit-stream pattern:
extracting a block, and reading a plurality of bits from said bit-stream of said block;
using said read bits to index an entry in said look-up table;
determining whether said entry being a match for said bit-stream patter based on a corresponding field of said field; and
if matched, obtaining said zig-zag ordered coefficients from said bit-stream zig-zag ordered coefficient table according to said matched bit-stream pattern.

6. The method as claimed in claim 4, wherein said entry of said look-up table further includes an index field, a field of bit length of the matched, a field of bit-stream pattern of the matched, and an ID number field of a said bit-stream pattern.

7. The method as claimed in claim 4, wherein said entry of said bit-stream pattern zig-zag ordered coefficient table further includes an ID number field of said bit-stream pattern, a field of said bit-stream pattern, and a field of zig-zag ordered coefficients corresponding to said bit-stream pattern.

8. The method as claimed in claim 5, wherein eight bits are being read from said bit-stream.

9. The method as claimed in claim 7, wherein said entry of said bit-stream pattern zig-zag ordered coefficient table further includes a field of the coefficients of said block after inverse quantization and inverse transformation.

10. The method as claimed in claim 1, wherein said table look-up mechanism constructs a hash table during said compression process.

11. The method as claimed in claim 10, wherein said hash table comprises 256 entries, and each said entry further includes an index field, a field of zig-zag ordered coefficients, an ID number field of said bit-stream pattern, and said bit-stream pattern.

12. The method as claimed in claim 10, wherein said matching zig-zag ordered coefficients further includes the steps of:
computing a hash value for said zig-zag ordered coefficients;
using said hash value to index an entry of said hash table;
determining whether said zig-zag ordered coefficients match being found; and
if matched, obtaining said corresponding bit-stream from said bit-stream pattern zig-zag ordered coefficient table.

13. A pattern-search based apparatus for variable length coding and decoding, comprising:
a decompression module having a pattern-search unit and an entropy decoder, cooperating with a look-up table, said pattern-search unit using an input bit-stream to match a corresponding bit-stream pattern, if matched, said pattern-search unit obtaining corresponding zig-zag ordered coefficients from said look-up table, if not matched, said pattern-search module informing said entropy decoder to perform an entropy decoding process; and
a compression module having a table look-up unit and an entropy coder, cooperating with a hash table, said table look-up unit matching input zig-zag ordered coefficients, if matched, said table look-up unit obtaining a bit-stream from said hash table, if not matched, said table look-up unit informing said entropy coder to perform an entropy coding process.

14. The apparatus as claimed in claim 13, wherein each entry of said look-up table further includes an index field, a field of bit length of the matched, a field of bit-stream pattern of the matched, and an ID number field of a said bit-stream pattern.

15. The apparatus as claimed in claim 13, wherein said hash table includes 256 entries, and each said entry further includes an index field, a field of zig-zag ordered coefficients, an ID number field of said bit-stream pattern, and said bit-stream pattern.

16. The apparatus as claimed in claim 14, wherein said pattern-search unit uses a byte from said bit-stream to index an entry of said look-up table for matching said bit-stream pattern.

17. The apparatus as claimed in claim 15, wherein said table look-up unit computes a hash value from said input zig-zag ordered coefficients, and said hash value is used to index an entry of said hash table for matching said input zig-zag ordered coefficients.
